(19) United States
(12) Patent Application Publication
(10) Pub. No.: US 2015/0154697 A1
(43) Pub. Date: Jun. 4, 2015

(54) System And Method For Accelerated Client Bank Account Opening

(71) Applicants: S. Richard RE, Westfield, NJ (US); Linda MUNRO, Park Ridge, IL (US)

(72) Inventors: S. Richard RE, Westfield, NJ (US); Linda MUNRO, Park Ridge, IL (US)

(73) Assignee: JPMORGAN CHASE BANK, N.A., New York, NY (US)

(21) Appl. No.: 12/832,197

(22) Filed: Jul. 8, 2010

(51) Int. Cl. G06Q 40/00; G06K 7/00; G06Q 50/18; G06F 17/30

(52) U.S. Cl. CPC G06Q 40/02; G06Q 50/18

(57) ABSTRACT

A system and method for accelerated client bank account opening is disclosed. In one embodiment, the method includes (1) using a computer network: (a) receiving identification information for a representative for a client; (b) receiving a request from the representative to open a new account for the client; and (2) using a computer processor: (a) verifying the representative's authority to open the new account; (b) determining if any documents are required from the client to open the new account; (c) receiving a selection of an account type to open for the client from the representative; and (d) opening the selected account type for the client. A method for accelerated bank account opening for a new client is disclosed. According to one embodiment, the method may include (1) using a computer network: (a) receiving a request from a representative to open an account for the a client; (b) receiving identification information for the representative; and (c) receiving information about the new client from the representative; and (2) using a computer processor: (a) opening a temporary account for the new client; (b) verifying the representative's authority to open the new account; (c) establishing an identity for the representative; (d) verifying the information about the new client; (e) providing documents to the representative for completion; (f) receiving completed documents from the representative; (g) receiving a selection of an account type to open for the client from the representative; and (h) opening the selected account type for the new client.

### BACKGROUND OF THE INVENTION

1. Field of the Invention

The present invention generally relates to client bank accounts, and, more particularly, to a system and method for accelerated client bank account opening.

2. Description of the Related Art

Presently, it can take up to thirty days for a bank account to be opened, even for an existing corporate customer. The primary reasons for this are legal and regulatory—much of the information that is gathered is required to be provided in hard copy format. Internal operational inefficiencies also contribute to delays in opening accounts.

### SUMMARY OF THE INVENTION

A system and method for accelerated client bank account opening is disclosed. In one embodiment, the method may include (1) using a computer network: (a) receiving identification information for a representative for a client; (b) receiving a request from the representative to open a new account for the client; and (2) using a computer processor: (a) verifying the representative's authority to open the new account; (b) determining if any documents are required from the client to open the new account; (c) receiving a selection of an account type to open for the client from the representative; and (d) opening the selected account type for the client.

In one embodiment, the step of verifying the applicant's authority to open the new account may include accessing at least one database to confirm that the representative is approved to open the new account for the client.

In one embodiment, the step of determining if any documents are required from the client may include accessing at least one database to verify that required documents are on file.

In one embodiment, the step of determining if any documents are required from the client may also include verifying that the required documents that are on file are valid.

In one embodiment, the step of determining if any documents are required from the client may include providing any missing documents to the representative for completion; and receiving the completed document from the client.

In one embodiment, the completed documents may be automatically received by one of facsimile and email.

In one embodiment, the step of receiving the completed documents from the client may include reading a machine-readable code on the completed document to identify the completed document; verifying that necessary portions of the completed documents have been completed, and updating a receipt status of the completed document.

In one embodiment, the step of receiving a selection of an account type to open for the client from the representative may include presenting the representative with at least one account type to open; receiving a selection of the account type to open; receiving additional information specific to the selected account type; and verifying the selected account type and information specific to the selected account type.

In one embodiment, the step of opening the selected account type for the client may include verifying the selected account type and information specific to the selected account type with an authorized client representative; and informing the representative that the account has been opened.

A method for accelerated bank account opening for a new client is disclosed. According to one embodiment, the method may include (1) using a computer network: (a) receiving a request from a representative to open an account for a new client; (b) receiving identification information for the representative; and (c) receiving information about the new client from the representative; and (2) using a computer processor: (a) opening a temporary account for the new client; (b) verifying the representative's authority to open the new account; (c) establishing an identity for the representative; (d) verifying the information about the new client; (e) providing documents to the representative for completion; (f) receiving completed documents from the representative; (g) receiving a selection of an account type to open for the client from the representative; and (h) opening the selected account type for the new client.

In one embodiment, the step of verifying the representative's authority to open the new account may include accessing at least one database to confirm that the representative is approved to open the new account for the new client.

In one embodiment, the step of establishing an identity for the representative may include presenting at least one question for the representative; and receiving a corresponding response for the at least one question from the representative.

In one embodiment, the step of verifying the information about the new client may include accessing at least one database to confirm the accuracy of the information about the new client.

In one embodiment, the step of receiving completed documents from the representative may include reading a machine-readable code on the completed document to identify the completed document; verifying that necessary portions of the completed documents have been completed, and updating a receipt status of the completed document.

In one embodiment, the step of receiving a selection of an account type to open for the client from the representative may include presenting the representative with at least one account type to open; receiving a selection of the account type to open; receiving additional information specific to the selected account type; and verifying the selected account type and information specific to the selected account type.

In one embodiment, the step of opening the selected account type for the client may include receiving an executed service agreement from the representative; and informing the representative that the account has been opened.

A system for accelerated client bank account opening is disclosed. According to one embodiment, the system comprises at least one computer processor; a memory; and an executable computer program that is tangibly embodied on a computer readable medium. The computer program may perform the following: (a) receive identification information for a representative for a client; (b) receive a request from the representative to open a new account for the client; (c) verify the representative's authority to open the new account; (d) determine if any documents are required from the client to open the new account; (e) receive a selection of an account type to open for the client from the representative; and (f) open the selected account type for the client.

The system may further comprise at least one database comprising client approval information for the representative; and at least one database that stores the documents.

The system may further comprise an interface that receives completed documents; and the executable computer program may further performs the steps of: reading a machine-readable code on the completed document to identify the completed document; verifying that necessary portions of the completed documents have been completed, and updating a receipt status of the completed document.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic of a system for accelerated client bank account opening according to an embodiment of the present invention;

FIG. 2 is flowchart depicting a method for accelerated client bank account opening according to an embodiment of the present invention;

FIGS. 3a-s are examples of a graphical user interface for a method for accelerated client bank account opening according to an embodiment of the present invention;

FIG. 4 is flowchart depicting a method for accelerated client bank account opening according to another embodiment of the present invention.

### DETAILED DESCRIPTION OF PREFERRED EMBODIMENTS

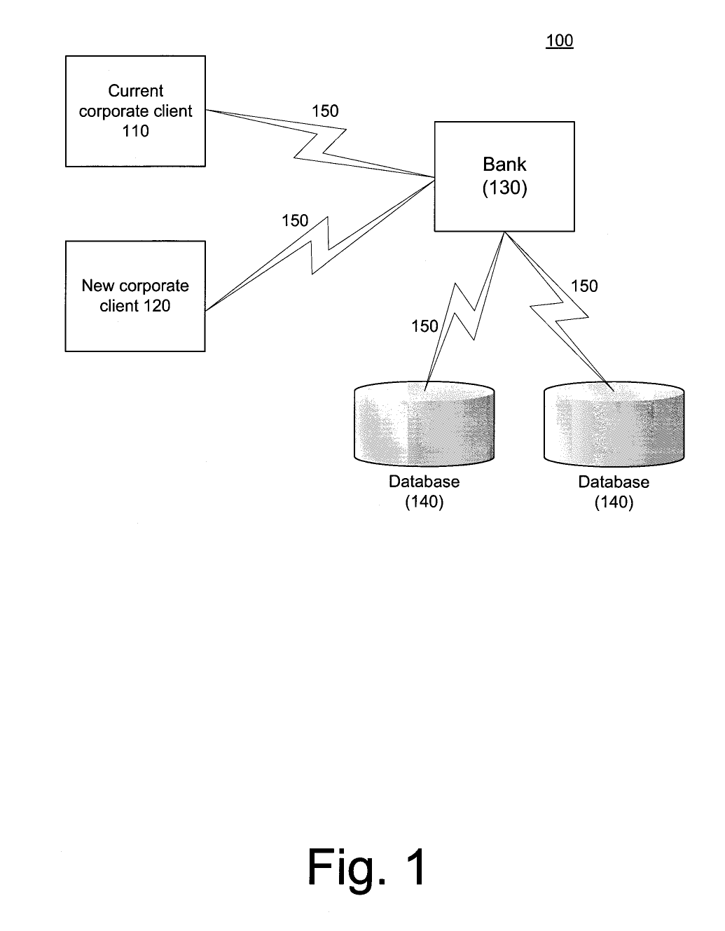

Several embodiments of the present invention and their advantages may be understood by referring to FIGS. 1-4 wherein like reference numerals refer to like elements.

The following disclosures are related to the present invention: U.S. patent application Ser. No. 11/968,018, entitled “System and Method For Processing Transactions Using A Multi-Account Transactions Device”; U.S. patent application Ser. No. 11/400,171, entitled “Method For Transaction Processing In A Capture and Deposit”; U.S. patent application Ser. No. 11/873,845 entitled “Method For Transaction Processing In A Capture and Deposit’ and U.S. patent application Ser. No. 11/770,321, entitled “Method For Marketing And Applying For Financial Products With A Mobile Device.” The disclosures of these applications and any continuations are incorporated by reference herein.

Opening a new account, even for a current client, involves a significant amount of effort. The process can be thought of as having four phases. The first phase, “initiation,” generally involves a manual request from a client or potential client received via a telephone, a facsimile, a courier, etc. Usually, this is a paper-intensive process.

The next phase, generally referred to as “information gathering,” may also be very paper intensive. This phase may involve the collection of documentation, including some that may already be on file. It may rely on the client's ability to understand to complete and return completed documents by mail. Because it is paper intensive, it may involve the processing and storage of these paper documents, which can be expensive.

The next phase, “validation,” involves manual verification of information. For example, it may involve checking with commercially-available databases. An example of such a database is iVault. Missing documentation may be identified. Because this is a manual check, however, it is subject to human error.

The last phase, “activation,” generally involves many different people, systems, and processes. Due to this, activation may require coordination in order for the process to run smoothly and efficiently.

According to one embodiment of the present invention, the process for opening new accounts may be accelerated for both current corporate customers (i.e., corporations that have existing relationships with the bank) and new corporate customers (i.e., those without an existing relationship with the bank). The present invention may eliminate the need for manual input, review, and/or filing of account information by an implementation staff. In one embodiment, it may minimize, if not completely eliminate, human interaction.

In one embodiment, the present invention facilitates the opening of a new account, and the providing of a new account number, during a single online session. For example, this may be achieved during a single web session. In one embodiment, the present invention also may be used to cross-sell other products to the client.

According to one embodiment, the initiation phase of the present invention may involve a dynamic, customer-centric online request “wizard.” In one embodiment, the request wizard may provide standard, machine readable request messages that may facilitate downstream automation. Further, account open requests may be re-directed to less costly self-service channel.

According to one embodiment, the information gathering phase of the present invention may involve collecting information in a single online exchange with the client or potential client. In one embodiment, for an existing client, data that is already in the possession of the bank may not be re-requested. The information gathering phase may also include tracking and alerts for pending documentation. The present invention may also use digital signatures and may include alerts for pending documentation. Machine-readable codes, for example, barcodes, or other document tracking mechanisms/devices may be used as necessary and/or desired.

According to one embodiment, the validation phase of the present invention may involve secure, automated authentication and authorization checks. In one embodiment, this may accelerate the speed of approvals. Further, identity verification/validation may be confirmed with external identity database vendors.

According to one embodiment, the activation phase of the present invention may be substantially automated to streamline workflow. In one embodiment, pre-defined, pre-configured product bundles may be offered to the client.

In one embodiment, paper request and ink signatures are replaced by electronic messages and digital security. Thus, downstream operations may be automated with little or no human intervention. This sort of processing may be referred to as “straight-through processing,” or STP.

Referring to FIG. 1, a block diagram of a system for accelerated client bank account opening is provided. In one embodiment, system 100 may include existing client 110, new client 120, bank 130, databases 140, and communication network 150.

Clients 110 and 120 may be any sort of clients, including business entities (e.g., corporations, partnerships, not for profits, government agencies, etc.), individuals, etc. Depending on the client or the entity that is requesting the account, however, the products and/or services offered, as well as the authentication mechanisms, may vary.

Clients 110 and 120 may access the bank's on-line presence via communication network 150. In one embodiment, communication network 150 may be any suitable mechanisms for communication. In one embodiment, communication network 150 may be the Internet. Alternately, clients 110 and 120 may access the bank's on-line presence using a kiosk. Other mechanisms for accessing bank 130's on-line presence may be used as necessary and/or desired.

Bank 130 may be any entity that opens and maintains an account. For example, Bank 130 may be any suitable financial institution, including national associations, state banks, credit unions, credit card companies, etc.

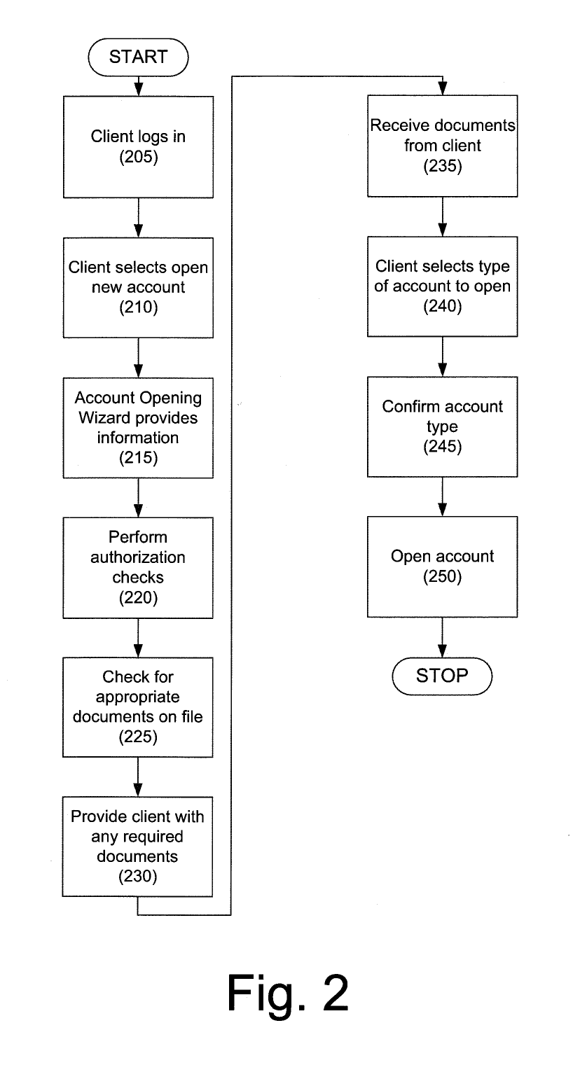

Referring to FIG. 2, a flowchart depicting a method for accelerated client bank account opening for a current client according to one embodiment of the present invention is provided.

In step 205, a current client accesses the bank's on-line presence. In one embodiment, this may be accomplished using the client's computer, mobile device, mobile phone, PDA, etc. to log on to the bank's website. In another embodiment, the client may access the bank's on-line presence using a kiosk or a terminal located at the bank. In still another embodiment, the client may submit its request by SWIFT, FMS, phone, mail, fax, email. Other ways for accessing the bank's on-line presence may be used as necessary and/or desired.

In step 210, the current client initiates the opening of a new account process. In one embodiment, the client may select a tab, radio button, etc. indicating that this is the action that he or she wishes to pursue.

In step 215, an “Account Opening Wizard” may provide information to the client before the process continues. In one embodiment, the client is provided with information regarding what is required to open account, how long it will take to open the account, etc.

In step 220, the system may perform authentication and authorization checks. For example, in one embodiment, the system may check to ensure that the client representative seeking to open the new account has account opening authority for the client. In one embodiment, the system may check at least one database to see if the client representative has been previously authorized for such actions by the client. In another embodiment, the system may check commercially-available databases to verify the representative's title.

In another embodiment, if additional approvals within the client are necessary, the system determines what additional approvals are necessary, including contact information for those approvals. This will be discussed in greater detail, below.

In step 225, the system checks to see if the appropriate documents are on file. In one embodiment, these documents may include a Certificate Regarding Accounts, Certificate of Incumbency, Service Terms, Account Terms, W8/W9, Signature Card, and any other necessary and/or desired documents.

In one embodiment, the system may access at least one database to determine if the documents are on file. In another embodiment, this may be performed manually. In another embodiment, the documents on file may be screened to verify that they are still valid. In one embodiment, this may include checking the document for completeness, timeliness, etc.

If any documents are required, in step 230, the documents may be provided or made available to the client. In one embodiment, the documents may be presented on-screen for the client, and may be signed and/or accepted electronically. In another embodiment, the documents may be downloaded from a website, emailed or faxed to the client, etc.

In one embodiment, the required documents may be sent to the client by mail.

In one embodiment, the documents may include a machine-readable code to assist in their processing upon their receipt.

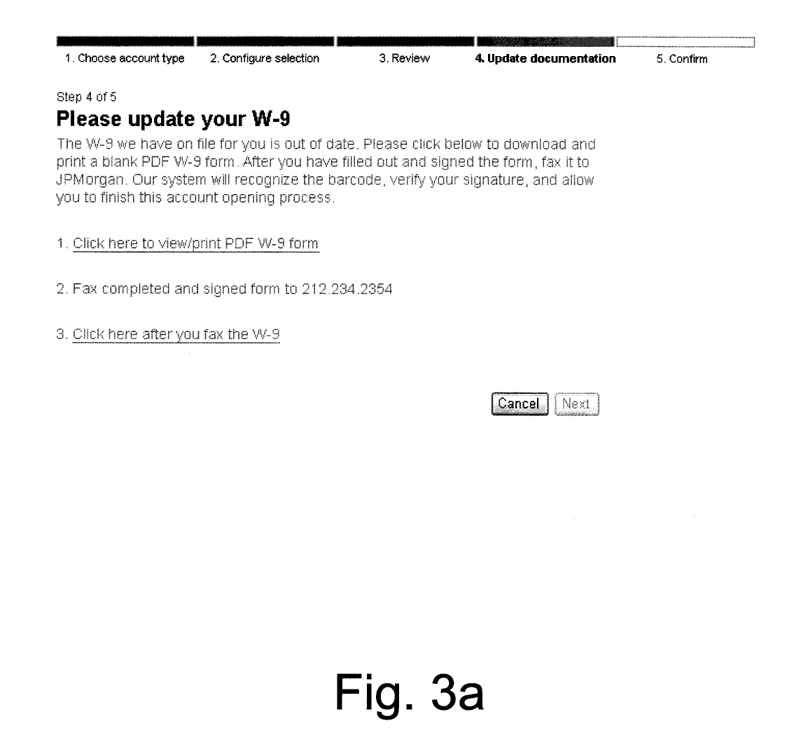

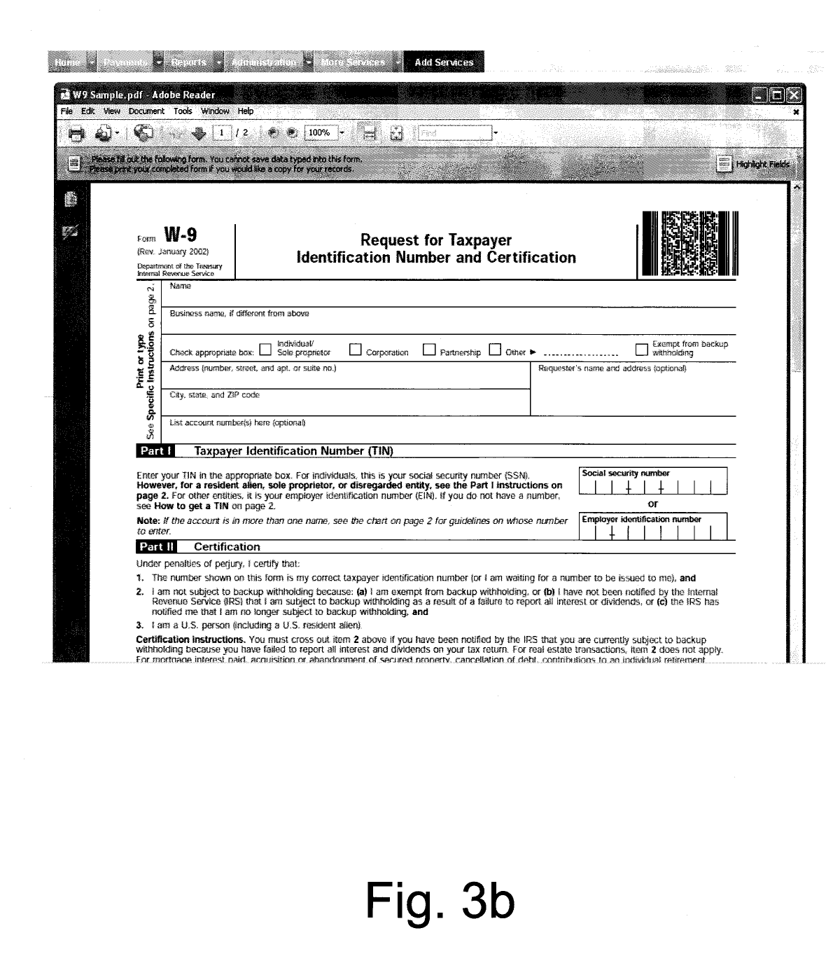

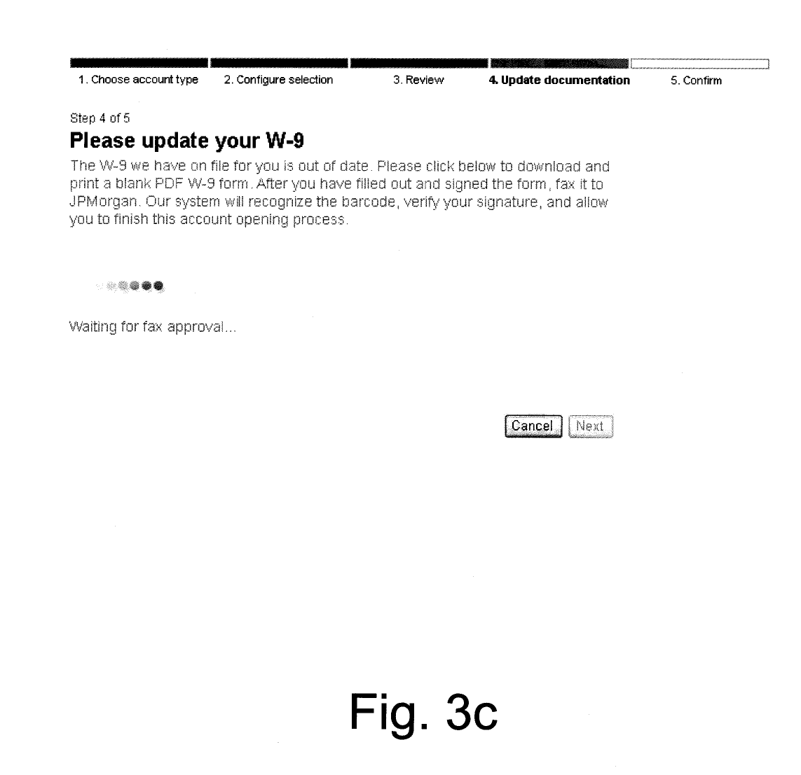

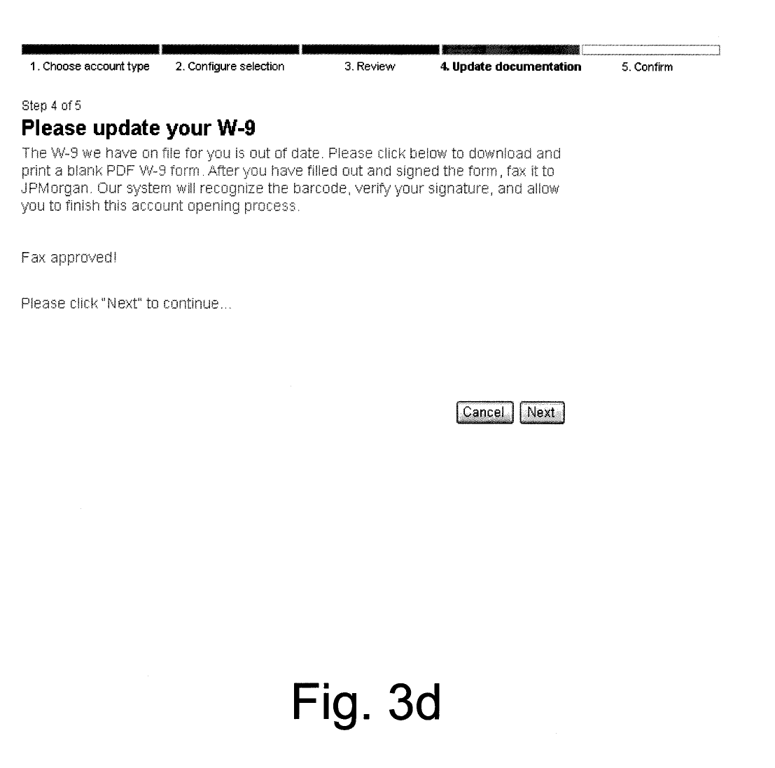

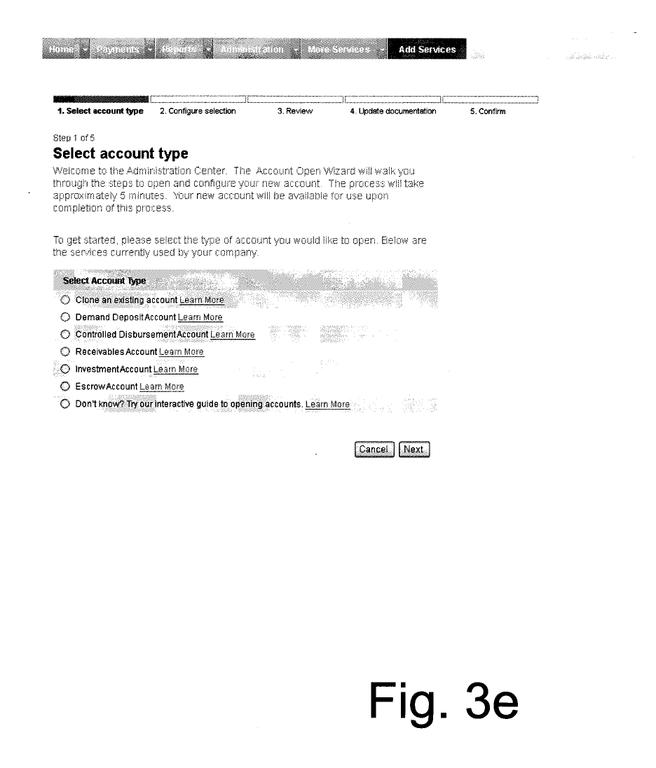

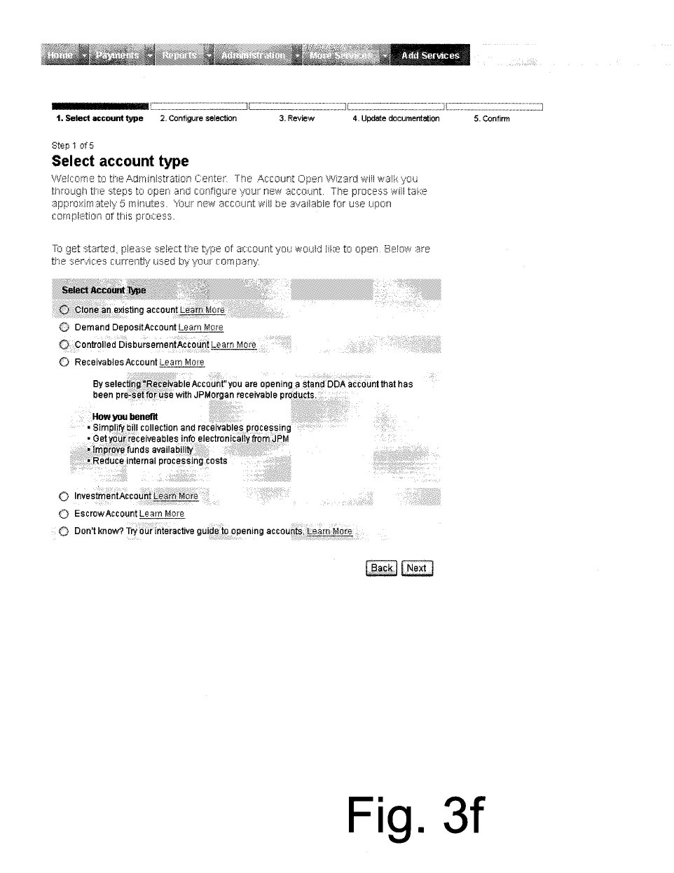

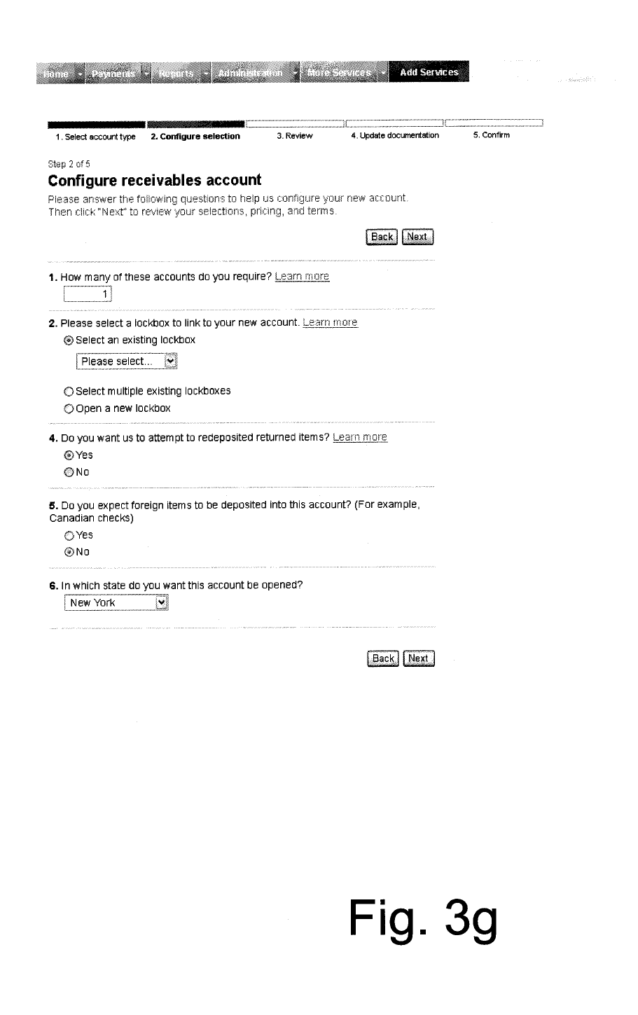

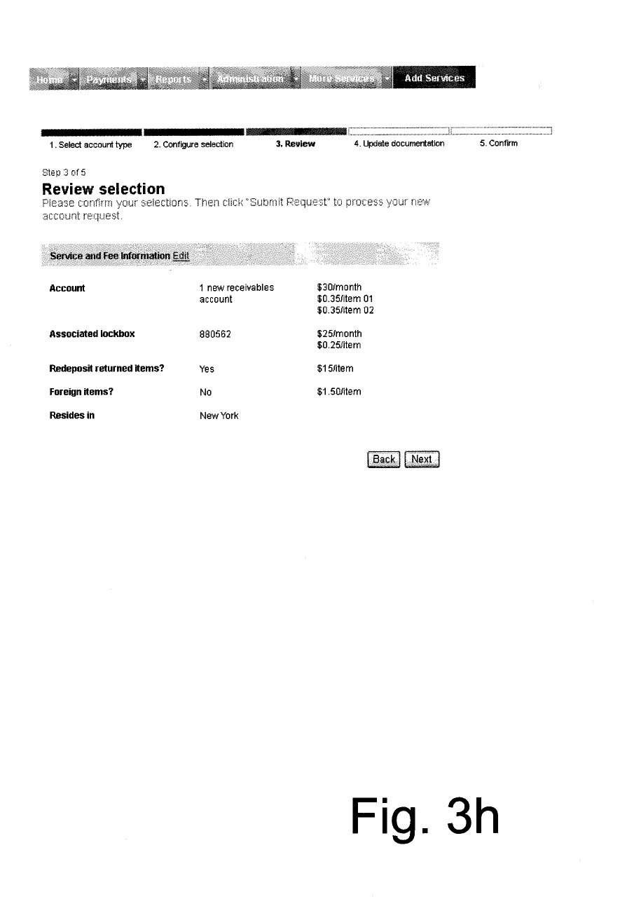

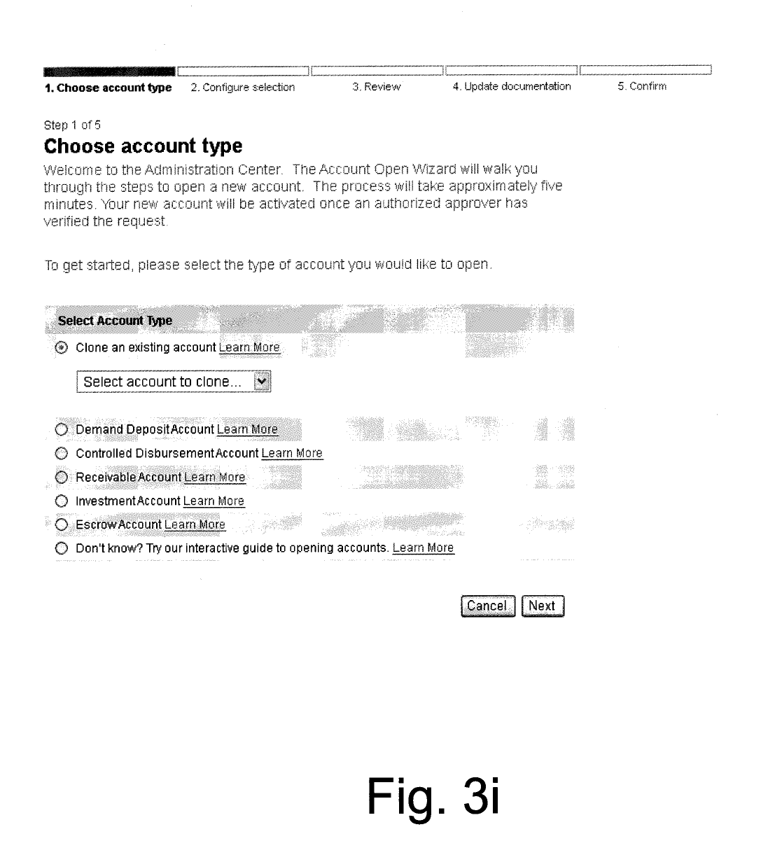

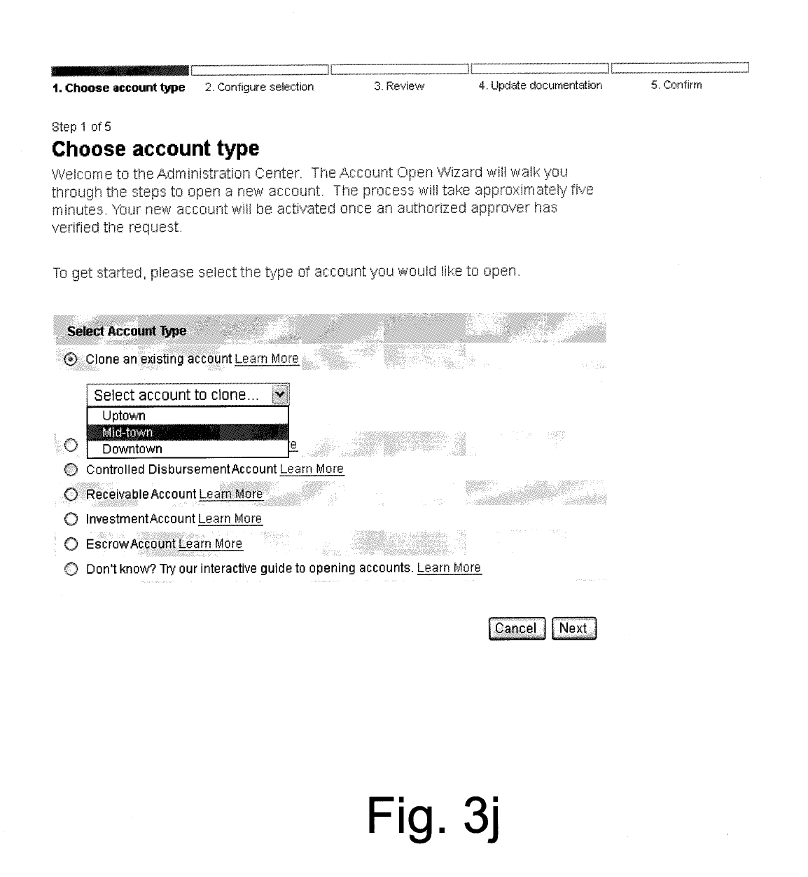

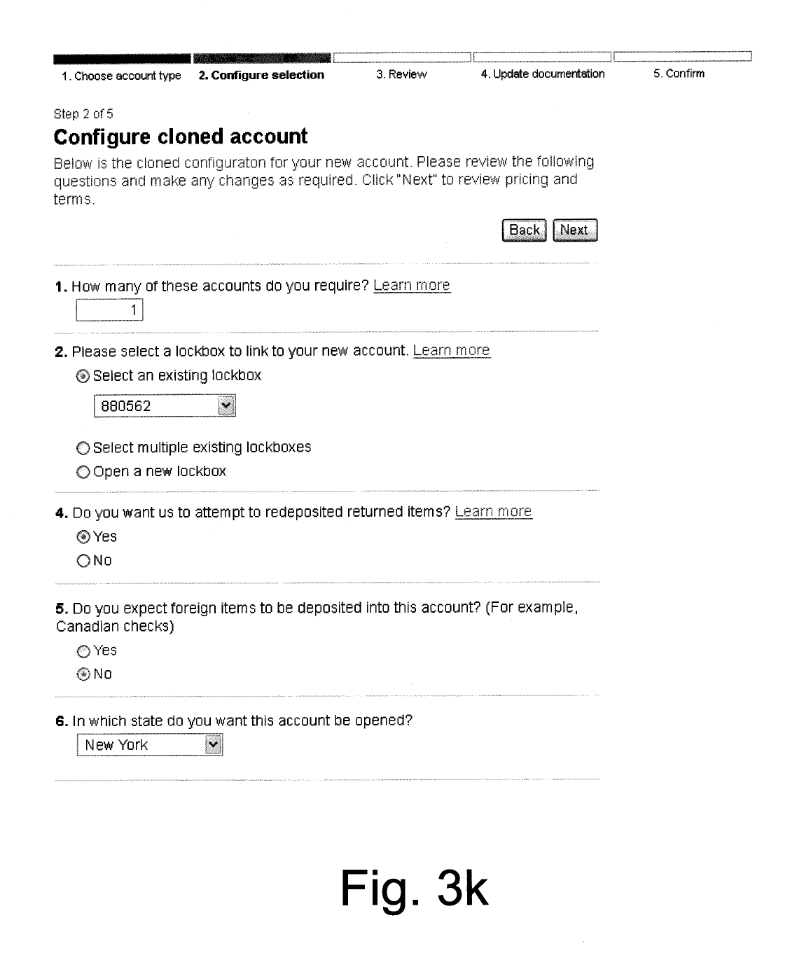

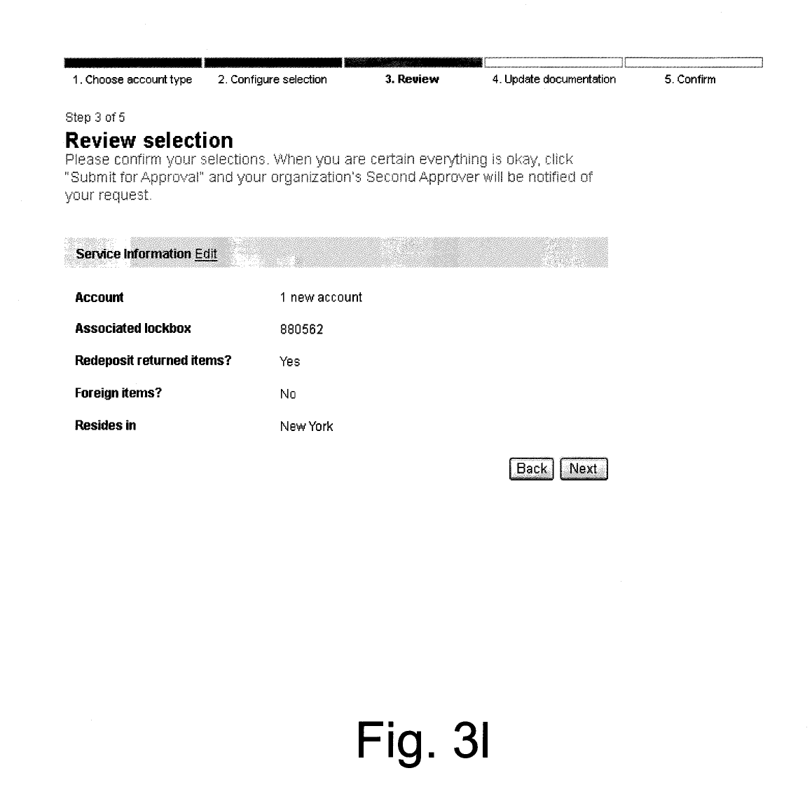

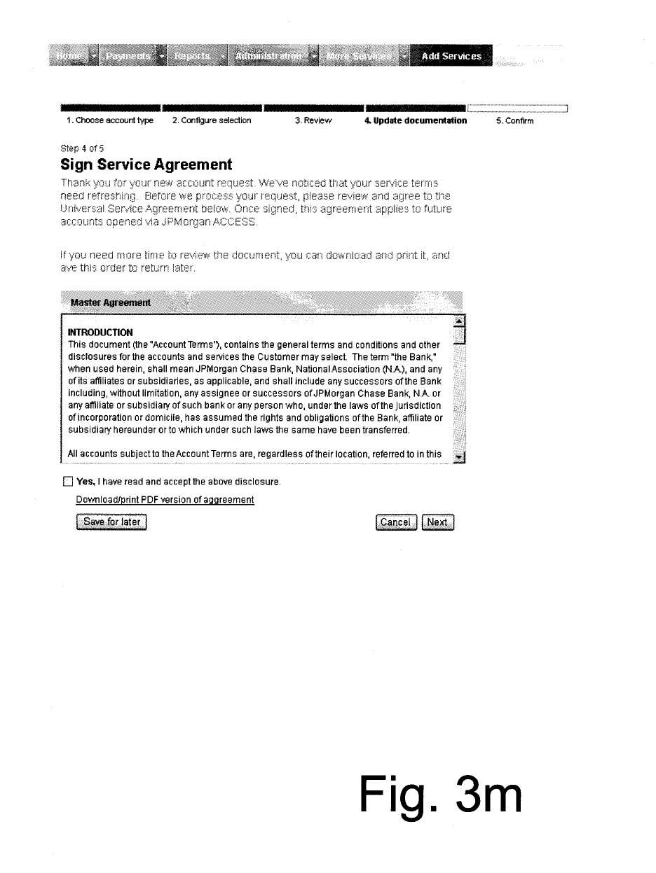

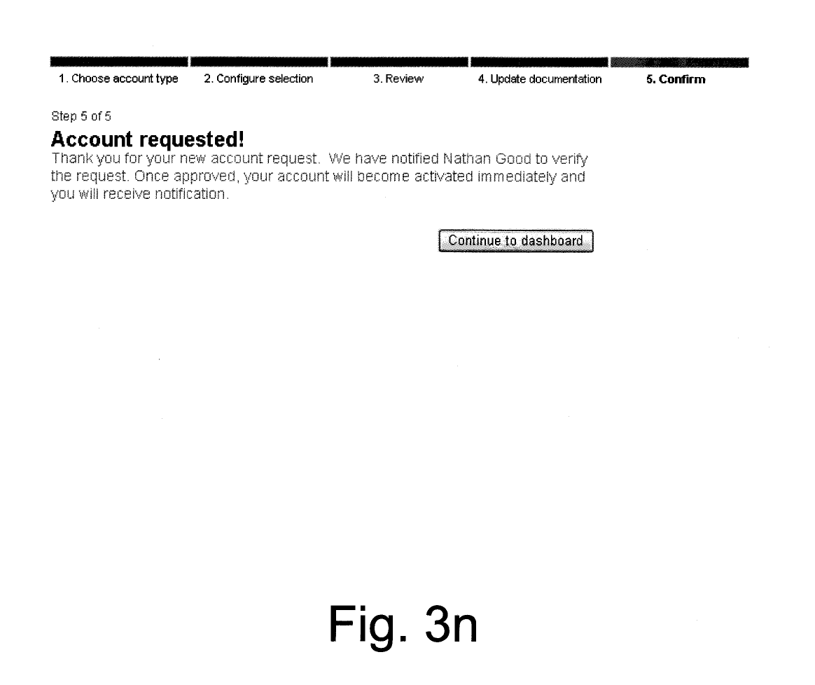

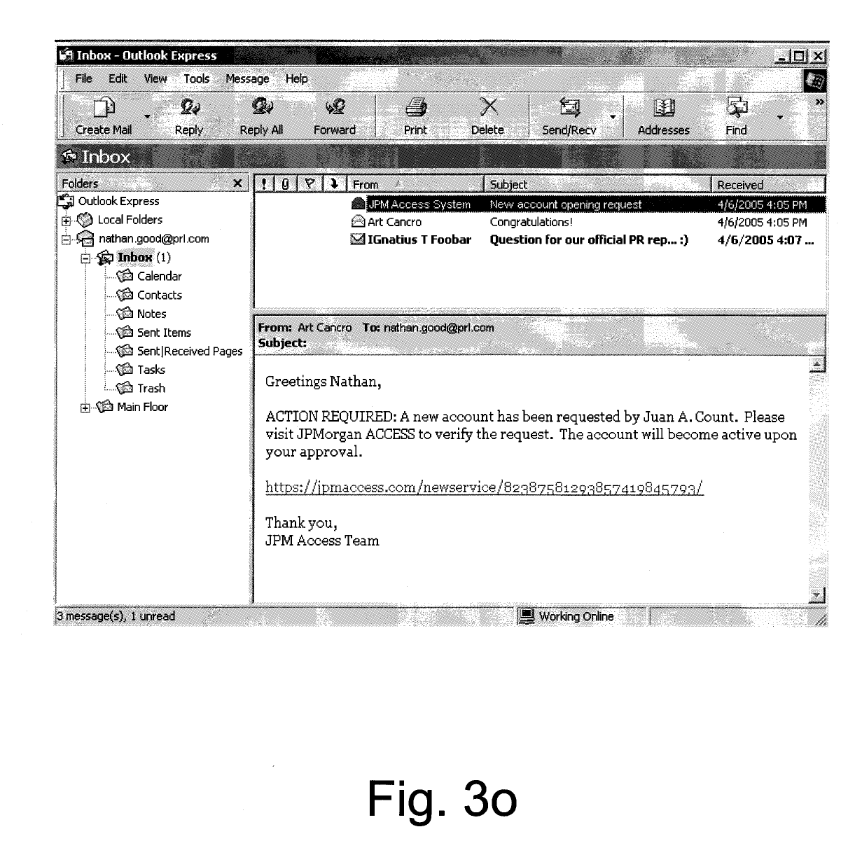

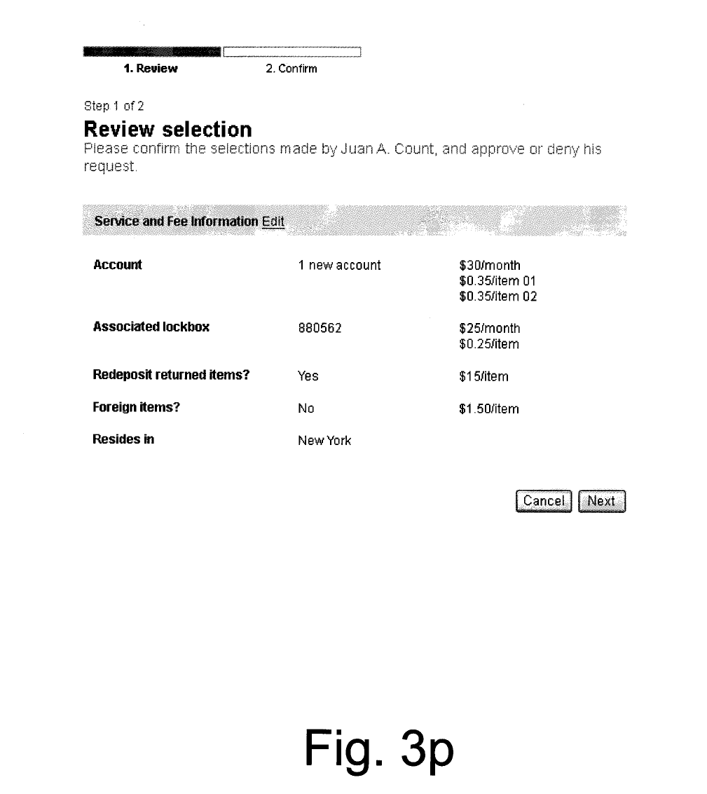

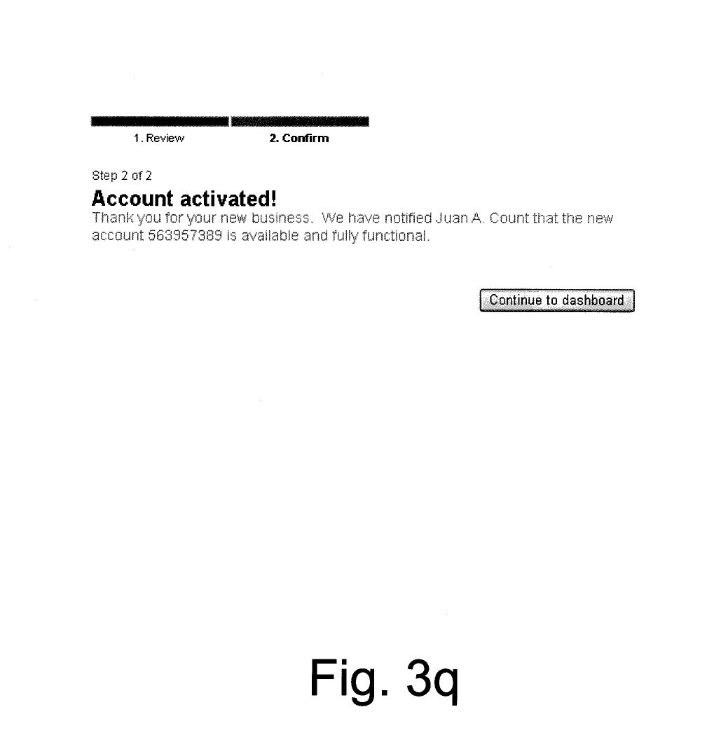

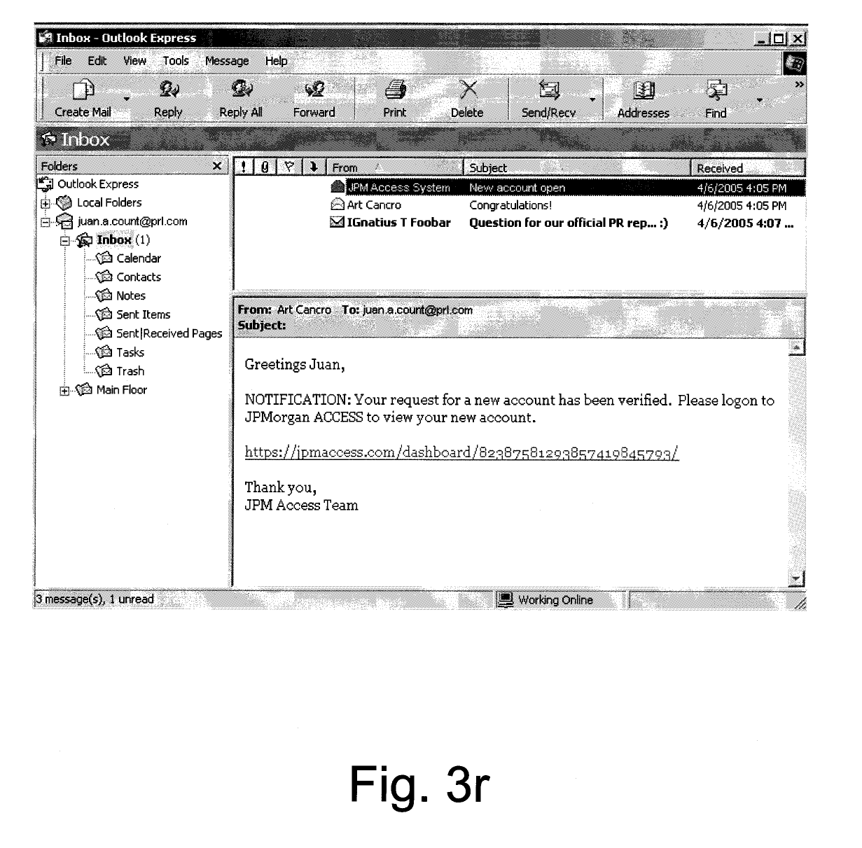

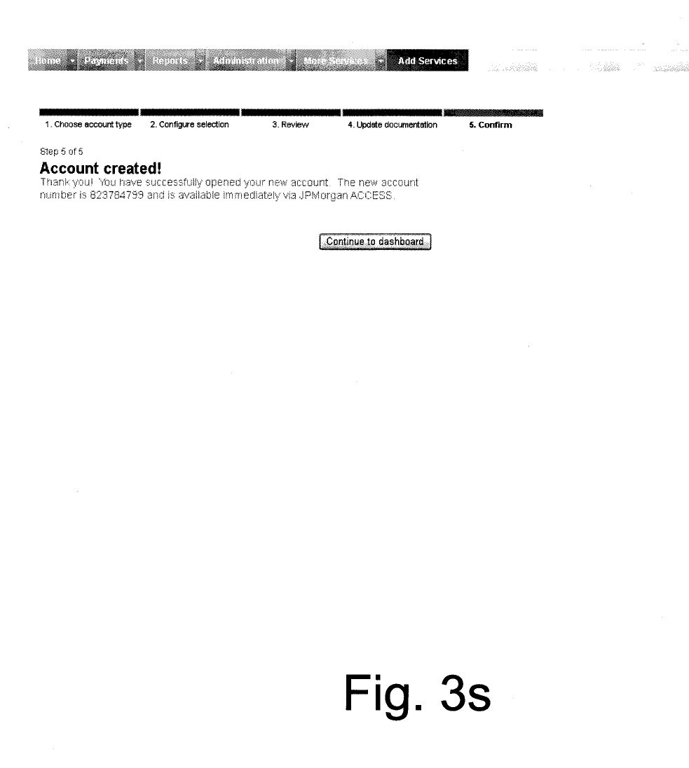

In one embodiment, referring to FIG. 3a, the client may be requested to update its form W-9. The client may be presented with the option of viewing/printing the W-9, and may be provided with instructions on how to return the form. FIG. 3b is an example screenshot of the W-9 form being presented to the client.

In step 235, documents may be received from the client. The documents may be provided by any suitable mechanism, including, for example, email, PDF, facsimile, on-line submission, regular mail, etc.

In one embodiment, the system may scan the document to verify that necessary portions have been completed by the client.

In one embodiment referring to FIG. 3c, after the client informs the system that the form is being returned by facsimile, the customer may be presented with a real-time status of the receipt of the document. Referring to FIG. 3d, the system may inform the client when the facsimile is received and approved.

A similar mechanism may be provided for other means of document transmittal.

In one embodiment, the system may update the status of the completed document to “received” following receipt.

In one embodiment, the client may be alerted if documents are not received by the Service Level Agreement, or SLA, date.

In step 240, the client may specify the account type that the client would like to open. In one embodiment, the client may be presented with options to assist in this decision, including, for example, cloning an existing account; selecting from a list of generic account types; answering questions to help the system determine the appropriate account type, etc. Other options may be provided as necessary and/or desired.

Referring to FIGS. 3e and 3f, example screenshots of the “Select Account Type” screens are provided. In FIG. 3a, the customer is presented with several different account types. It should be recognized that the account types and number of accounts shown in FIG. 3e are for illustrative purposes only. The client may be presented with the opportunity to find out more information about each type of account by clicking, highlighting, selecting, rolling over, etc. a link or similar element. In the example shown, a “learn here” link is provided for this purpose. FIG. 3f illustrates an example of the results of the client selecting “learn more” for the “Receivables Account.”

Following the selection of the account, the client may be presented with the opportunity to configure the account. This may include, for example, selecting the number of accounts to open, linking the account to a lockbox, identifying the state in which the account will be opened, etc. An example screenshot for the configuration of a receivables account is shown in FIG. 3g.

Referring again to FIG. 2, following the selection of the account type, in step 245, the system may display the new account attributes, and request that the user confirm the account type, or make changes to the account type. An example screenshot for the review and confirmation of a receivables account is shown in FIG. 3h.

In another example, the client decides to clone an existing account. Referring to FIG. 3i, the client may select the “clone existing account” button. In FIG. 3j, the client may be presented with a menu as to which account the client would like to clone. In FIG. 3k, the client may be requested to configure the cloned account by, for example, entering the number of accounts to create, specify a lockbox or request a new lockbox, identify the state in which the account should be opened, and other administrative issues. In FIG. 3l, the client may be asked to review the configuration selections it made.

In one embodiment, the client may be required to electronically sign a service or similar agreement. The service agreement may be presented online, may be downloaded, or provided in hard copy. An example screenshot for the service agreement execution is shown in FIG. 3m.

Referring again to FIG. 2, in step 250, the account is opened. Depending on the authority held by the representative acting on behalf of the corporate customer, the account may be immediately opened, or it may require authorization from a person having the requisite authority.

In one embodiment, this may also include associating any products and/or services to the account, configuring the products and/or services to client specifications, etc.

For example, referring to FIG. 3n, the person opening the account may be informed that an account has been requested, and that the system is verifying the request with a person with approving authority.

In one embodiment, the system may request approval by any suitable communication method, including, for example, email, text, voice, facsimile, etc. Referring to FIG. 3o, a screenshot of the email inbox of a person with approving authority is provided. In one embodiment, the person with approving authority may approve the opening of the account by clicking on a link, responding to an email, calling a telephone number, etc.

In one embodiment, referring to FIG. 3p, the person with approving authority may be presented with the account specifics, and asked to confirm that this account is to be opened. In one embodiment, the person with approving authority may make edits to the account configuration.

Once the person with approving authority approves the account, in FIG. 3q, the system may inform the person that the account has been opened, and that it is notifying the person who entered the data for the new account.

Referring to FIG. 3r, the system may inform the person who entered data for the new account that the account opening has been approved.

In FIG. 3s, the system informs that the account has been created.

Once the account is opened, it is provided to the client on the client's summary page.

In addition, in one embodiment, the present invention may accelerate the process for opening an account for a new client. In general, before opening an account for a new client, it may be necessary to gather and/or verify additional information about that client and/or the client representative who is opening the account. For example, in one embodiment, it is necessary for the identity of the person representing the corporate customer to be confirmed. This may be done by a human (e.g., by a telephone call) or electronically (e.g., by automated telephone calling, email, voice response system, etc.). In one embodiment, public databases may be consulted to complete this verification.

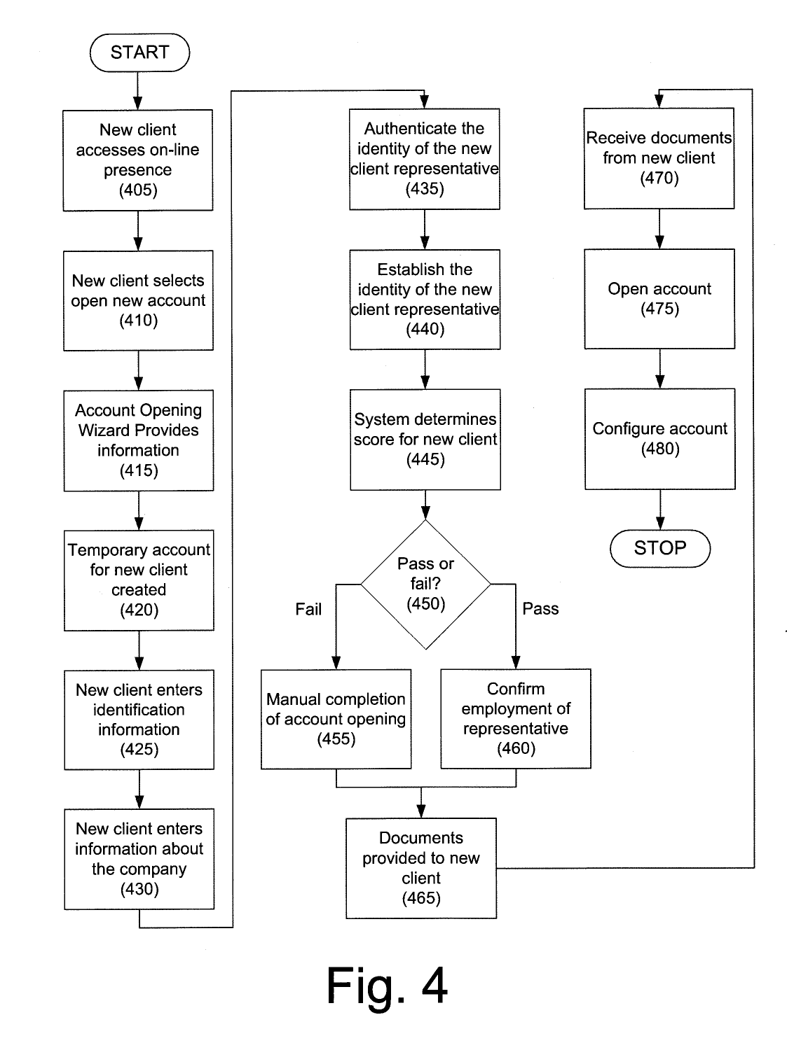

Referring to FIG. 4, a flowchart depicting a method for accelerated client bank account opening for a new client according to one embodiment of the present invention is provided.

In step 405, a new client accesses the bank's on-line presence. In one embodiment, this may be accomplished using the client's computer, mobile device, PDA, etc. to log on to the bank's website. In another embodiment, the client may access the bank's on-line presence using a kiosk or a terminal located at the bank. Other ways for accessing the bank's on-line presence may be used as necessary and/or desired.

In step 410, the new client initiates the opening of a new account process. In one embodiment, the client may select a tab, radio button, etc. indicating that this is the action that he or she wishes to pursue.

In step 415, an “Account Opening Wizard” may provide information to the client before the process continues. In one embodiment, the client is provided with information regarding what is required to open account, how long it will take to open the account, etc. For the new client, in one embodiment, the new client may be informed that a temporary on-line account will be created.

In one embodiment, the Account Opening Wizard may gather data from the client to select the type of account to be opened.

In step 420, a secure, temporary account may be created for the new client.

In step 425, the new client is prompted to enter identification information. For example, the new client may be requested to provide its name, address, social security number, date of birth, job title, drivers license number, etc. In one embodiment, the person entering the data on behalf of the new client may also be requested to provide his or her name, and a description of his or her position with the client.

In step 430, the new client may be prompted to enter information about the company (i.e., “know your customer” information”). For example, the new client may be prompted to enter the company's legal name, business address, establishment date, some or all of tax identification number, number of employees, business/industry type, revenue ranges, client representative/applicant name, phone number, email address, etc. In one embodiment, some this information may be provided in drop-down menus, radio buttons, etc.

In step 435, to the extent it is possible, the system may verify the information provided. In one embodiment, the system may access publicly-available databases to perform this verification. Examples of publicly-available databases include Equifax, Moody's, Standard & Poors, Lexis, telephone records, state governmental records, etc.

In step 440, the system may establish the identity of the client representative. In one embodiment, the system may present questions, for example, “out-of-wallet” questions, for the new client representative. Example out-of-wallet questions include, for example, “What was the color of your first car?”; “What is the name the first school you attended?”; “What is the name of the hospital you were born in?”; etc.

Other questions and/or types of questions may be used as necessary and/or desired.

In one embodiment, the system may further check legal databases to the extent possible to identify representatives/applicants with bad intentions. In one embodiment, the system may check the Office of Foreign Assets Control, or OFAC.

In step 445, the system may determine a score for the data entered by the new client representative. Any data that is collected from the new client, as well as any data that is collected from third party sources, may be used. In one embodiment, an algorithm may be applied to the data collected to determine this score. The algorithm may give greater or lesser weight to aspects of the data depending on, for example, its value in predicting a good client, reliability, etc.

If, in step 450, if the new client fails the validation process (e.g., has a low score), in step 455, the system may use manual interaction with the new client representative in order to complete the account opening. In one embodiment, the system may use a customer service call, on-line chat, secure email, etc. in order to communicate with the new client representative. Other methods of communication may be used as necessary and/or desired.

If the new client passes the validation process (e.g., has a high score), the system may use a manual process to validate the new client representative's employment with the new client. This may include, for example, contacting the new client representative directly; calling the main number for the new client and being routed to the new client representative; etc.

In one embodiment, the verification may use an automated process to validate the representative's employment. For example, an automated voice-response system may be used to call the persons employment and request validation.

In step 465, the new client is provided with the documents that may be required to open the new account. These documents may include, for example, a request to open an account, a certificate regarding accounts, a security administrator designation form, etc. Other documents may be provided as necessary and/or desired.

As noted above, these document may be provided with machine-readable codes, for example, barcodes, or other document tracking mechanisms/devices may be used as necessary and/or desired.

In step 470, the documents may be received from the new client. The documents may be provided by any suitable mechanism, including, for example, email, PDF, facsimile, on-line submission, regular mail, etc.

In one embodiment, once the documents are received, the system may note the receipt of the documents.

In step 475, the account may be opened. In one embodiment, this may include configuring the temporary account to be a full client account. In another embodiment, this may also include sending the client a network security device. In one embodiment, this may be a secure ID token. In another embodiment, the client is provided with the new account number.

In step 480, a security administrator may configure the new account. In one embodiment, the security administrator may be a client user with special access to the system. In one embodiment, the security administrator may add products and services to the account, allow access to additional users, etc.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, communications channel, a satellite transmission, memory card, SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for accelerated client bank account opening, comprising:
receiving, at an electronic interface for a financial institution and directly from an employee of a client, identification information for the employee;
receiving, at the electronic interface for the financial institution, a request entered by the employee to open a new account for the client;
at least one computer processor for the financial institution verifying that the employee is authorized by the client to open the new account;
receiving, at the electronic interface for the financial institution, client information entered by the employee;
the at least one computer processor for the financial institution verifying the received client information against data in at least one database;
the at least one computer processor for the financial institution determining if any documents are required from the client to open the new account;
receiving, at the electronic interface for the financial institution, a selection of an account type to open for the client entered by the employee; and
the at least one computer processor for the financial institution opening the selected account type for the client.

2. (canceled)

3. The method of claim 1, wherein the step of determining if any documents are required from the client comprises:
the at least one computer processor for the financial institution accessing at least one database to verify that required documents are on file.

4. The method of claim 3, wherein the step of determining if any documents are required from the client further comprises:
the at least one computer processor for the financial institution verifying that the required documents that are on file are valid.

5. The method of claim 1, wherein the step of determining if any documents are required from the client comprises:
providing any missing documents to the employee for completion; and
receiving the completed document from the client.

6. The method of claim 5, wherein the completed documents are automatically received by one of facsimile and email.

7. The method of claim 5, wherein the step of receiving the completed documents from the client comprises:
the at least one computer processor for the financial institution reading a machine-readable code on the completed document to identify the completed document, wherein the machine-readable code comprises a bar code;
the at least one computer processor for the financial institution verifying that necessary portions of the completed documents have been completed, and
the at least one computer processor for the financial institution updating a receipt status of the completed document.

8. The method of claim 1, wherein the step of receiving, at the electronic interface, a selection of an account type to open for the client entered by the employee comprises:
presenting the employee with at least one account type to open;
receiving, at the electronic interface for the financial institution, the selection of the account type to open;
receiving, at the electronic interface for the financial institution, additional information specific to the selected account type; and
the at least one computer processor for the financial institution verifying the selected account type and information specific to the selected account type.

9. The method of claim 1, wherein the step of opening the selected account type for the client comprises:
the at least one computer processor for the financial institution verifying the selected account type and information specific to the selected account type with an authorized client employee; and
informing the employee that the account has been opened.

10. A method for accelerated bank account opening for a new client, comprising:
receiving, at an electronic interface for a financial institution and directly from an employee of a new client, a request to open an account for a new client;
receiving, at the electronic interface for the financial institution, identification information for the employee;
receiving, at the electronic interface for the financial institution, information about the new client from the employee;
at least one computer processor for the financial institution opening a temporary account for the new client;
the at least one computer processor for the financial institution verifying that the employee is authorized by the new client to open the new account;
the at least one computer processor for the financial institution establishing an identity for the employee;
the at least one computer processor for the financial institution verifying the received information about the new client against data in at least one database;
the at least one computer processor for the financial institution providing documents to the employee for completion;
the at least one computer processor for the financial institution receiving completed documents from the employee;
receiving, at the electronic interface for the financial institution, a selection of an account type to open for the client from the employee; and
the at least one computer processor for the financial institution opening the selected account type for the new client.

11. (canceled)

12. The method of claim 10, wherein the step of establishing an identity for the employee comprises:
presenting at least one question for the employee;
receiving, at the electronic interface for the financial institution, a corresponding response for the at least one question from the employee.

13. The method of claim 10, wherein the at least one database used to verify the client information is a commercial database.

14. The method of claim 10, wherein the step of receiving completed documents from the employee comprises:
reading a machine-readable code on the completed document to identify the completed document;
verifying that necessary portions of the completed documents have been completed; and
updating a receipt status of the completed document.

15. The method of claim 10, wherein the step of receiving, at the electronic interface, a selection of an account type to open for the client from the employee comprises:
presenting, at the electronic interface for the financial institution, the employee with at least one account type to open;
receiving, at the electronic interface for the financial institution, a selection of the account type to open;
receiving, at the electronic interface for the financial institution, additional information specific to the selected account type; and
the at least one computer processor for the financial institution verifying the selected account type and information specific to the selected account type.

16. The method of claim 10, wherein the step of opening the selected account type for the client comprises:
receiving an executed service agreement from the employee; and
informing the employee that the account has been opened.

17. A system for accelerated client bank account opening, comprising:
at least one computer processor for the financial institution;
a memory;
an electronic interface for a financial institution; and
an executable computer program that is tangibly embodied on a computer readable medium, which performs the following:
receive, at the electronic interface for the financial institution and directly from an employee of a client, identification information for the employee;
receive, at the electronic interface for the financial institution, a request entered by the employee to open a new account for the client;
verify that the employee is authorized by the client to open the new account;
receiving, at the electronic interface for the financial institution, client information entered by the employee;
verifying the received client information against data in at least one database;
determine if any documents are required from the client to open the new account;
receive, at the electronic interface for the financial institution, a selection of an account type to open for the client entered by the employee; and
open the selected account type for the client.

18. (canceled)

19. The system of claim 17, further comprising:
at least one database that stores the documents.

20. The system of claim 17, wherein the executable computer program further performs the steps of:
reading a machine-readable code on the completed document to identify the completed document;
verifying that necessary portions of the completed documents have been completed; and
updating a receipt status of the completed document.

21. The method of claim 1, wherein the step of verifying that the employee is authorized by the client to open the new account comprises:
requesting approval from an approving authority at the client; and
receiving approval from the approving authority.

22. The method of claim 1, wherein the at least one database used to verify the client information is a commercial database.

23. The method of claim 1, further comprising:
confirming the selected account type before opening the selected account type for the client.

24. The method of claim 1, further comprising:
the at least one computer processor validating the employee comprising:
presenting a plurality of information requests to the employee;
receiving a response to each of the plurality of information requests from the employee;
the at least one computer processor comparing the responses to expected responses;
the at least one computer processor generating a score for the employee's response; and
validating the employee if the score is above a predetermined threshold.
